(19) United States
(12) Patent Application Publication
(10) Pub. No.: US 2010/0252747 A1
(43) Pub. Date: Oct. 7, 2010

(54) FLUORESCENCE DETECTION DEVICE

(75) Inventors: Takahisa Nakano, Kawasaki-shi (JP); Tsutomu Saito, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/549,942

(22) Filed: Aug. 28, 2009

(30) Foreign Application Priority Data
Apr. 7, 2009 (JP) 2009-093217

(51) Int. Cl. G01J 1/58

(52) U.S. Cl. 250/458.1; 250/208.2

(57) ABSTRACT

A fluorescence detection device is configured to detect a fluorescent substance which is attached to an inspected medium and glows at a specific wavelength. The detection device includes an illumination device configured to apply excitation light for exciting a fluorescent substance to an inspected medium, a first photoreceptor configured to receive excited light from the fluorescent substance of the inspected medium and detect only light of a specific wavelength, a second photoreceptor configured to receive excited light from the fluorescent substance of the inspected medium and detect light in a wider frequency band including the specific wavelength, and an authentication section configured to authenticate the fluorescent substance based on detection signals from the first and second photoreceptors.

### CROSS-REFERENCE TO RELATED APPLICATIONS

This application is based upon and claims the benefit of priority from prior Japanese Patent Application No. 2009-093217, filed Apr. 7, 2009, the entire contents of which are incorporated herein by reference.

### BACKGROUND OF THE INVENTION

1. Field of the Invention

This invention relates to a fluorescence detection device configured to detect a fluorescent substance attached to an inspected medium, such as a sheet of paper, and authenticate the inspected medium.

2. Description of the Related Art

In recent years, fluorescent printing for authentication has been done on some sheets of paper, such as paper money. A security information medium reader disclosed in Jpn. Pat. Appln. KOKAI Publication No. 2007-193387 is proposed as a device for detecting the fluorescent printing on the sheets of paper. In this security information medium reader, an information medium is irradiated successively by infrared, ultraviolet, and visible-light LEDs. Fluorescence emitted from the information medium is captured by a CCD camera, and a fluorescence pattern image and fine high-definition pattern are displayed on a monitor of a personal computer. According to this device, a fluorescence that glows at a specific wavelength is detected by a light receiving element through a filter that transmits light of the specific wavelength only.

A novel method and device for identifying printed matter are proposed in Jpn. Pat. Appln. KOKAI Publication No. 2006-275578. According to this method or device, two or more light emission characteristics and/or afterglow characteristic spectra emitted from a fluorescent substance and/or phosphor attached to printed matter are captured. The captured spectra are measured to detect a specific pattern of the fluorescent substance and/or phosphor, whereby the printed matter is identified.

In the security information medium reader disclosed in Jpn. Pat. Appln. KOKAI Publication No. 2007-193387, the phosphor is detected by the light receiving element through the filter that transmits light of the specific wavelength only. In this case, phosphors that glow at some other wavelengths in a wider frequency band that includes the specific wavelength can also be detected, so that it is difficult to perform valid authentication.

Although the identification method and device disclosed in Jpn. Pat. Appln. KOKAI Publication No. 2006-275578 can solve the above problem, the identification based on spectrometry or measurement of light emission characteristic spectra requires complex equipment and processing.

### BRIEF SUMMARY OF THE INVENTION

This invention has been made in consideration of these circumstances, and its object is to provide a fluorescence detection device capable of accurately detecting a fluorescent substance that glows at one or more specific wavelengths and easily performing authentication processing.

According to an aspect of the invention, there is provided a fluorescence detection device for detecting a fluorescent substance which is attached to an inspected medium and glows at a specific wavelength, comprising: an illumination device configured to apply excitation light for exciting the fluorescent substance to the inspected medium; a first photoreceptor configured to receive excited light from the fluorescent substance of the inspected medium and detect only light of the specific wavelength; a second photoreceptor configured to receive excited light from the fluorescent substance of the inspected medium and detect light in a wider frequency band including the specific wavelength; and an authentication section configured to authenticate the fluorescent substance based on detection signals from the first and second photoreceptors.

According to another aspect of the invention, there is provided a fluorescence detection device for detecting a fluorescent substance which is attached to an inspected medium and glows at a plurality of different specific wavelengths, comprising: an illumination device configured to apply a plurality of excitation light components of different wavelengths for individually exciting the fluorescent substance to the inspected medium; a first photoreceptor configured to receive excited light from the fluorescent substance of the inspected medium and detect only light of a first one of the different specific wavelengths; a third photoreceptor configured to receive excited light from the fluorescent substance of the inspected medium and detect only light of a second one of the different specific wavelengths; a second photoreceptor configured to receive excited light from the fluorescent substance of the inspected medium and detect light in a wider frequency band including the first and second specific wavelengths; and an authentication section configured to authenticate the fluorescent substance based on detection signals from the first, third, and second photoreceptors.

According to this arrangement, there is provided a fluorescence detection device capable of accurately detecting a fluorescent substance that glows at one or more specific wavelengths and easily performing authentication processing.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a side view schematically showing an outline of a fluorescence detection device according to a first embodiment of the invention;

FIG. 2 is a graph showing light emission characteristics of a fluorescence to be detected by the fluorescence detection device and light receiving characteristics of photoreceptors;

FIG. 3 is a block diagram showing an authentication section of the fluorescence detection device;

FIG. 4 is a graph showing light emission characteristics of the fluorescence detected by the fluorescence detection device and light receiving characteristics of the photoreceptors;

FIG. 5 is a graph showing broad light emission characteristics of the fluorescence detected by the fluorescence detection device and light receiving characteristics of the photoreceptors;

FIG. 6 is a side view schematically showing an outline of a fluorescence detection device according to a second embodiment of the invention;

FIG. 7 is a graph showing light emission characteristics of a fluorescence detected by the fluorescence detection device of the second embodiment and light receiving characteristics of photoreceptors;

FIG. 8 is a block diagram showing an authentication section of the fluorescence detection device of the second embodiment;

FIG. 9 is a graph showing light emission characteristics of the fluorescence detected by the fluorescence detection device of the second embodiment and light receiving characteristics of the photoreceptors;

FIG. 10 is a graph showing broad light emission characteristics of the fluorescence detected by the fluorescence detection device of the second embodiment and light receiving characteristics of the photoreceptors;

FIG. 11 is a side view schematically showing an outline of a fluorescence detection device according to a third embodiment of the invention;

FIG. 12 is a block diagram showing an authentication section of the fluorescence detection device of the third embodiment;

FIG. 13 is a graph showing a signal output of a first photoreceptor and transmission characteristics of optical filters of the fluorescence detection device of the third embodiment;

FIG. 14 is a side view schematically showing the outline of the fluorescence detection device according to the third embodiment;

FIG. 15 is a block diagram showing the authentication section of the fluorescence detection device of the third embodiment;

FIG. 16 is a graph showing a signal output of a second photoreceptor and transmission characteristics of optical filters of the fluorescence detection device of the third embodiment;

FIG. 17 is a diagram showing a lamp control signal output from a control section of the fluorescence detection device of the third embodiment;

FIG. 18 is a graph showing light emission characteristics of a fluorescence to be detected by the fluorescence detection device of the third embodiment and light receiving characteristics of photoreceptors; and

FIG. 19 is a graph showing light emission characteristics of the fluorescence to be detected by the fluorescence detection device of the third embodiment and light receiving characteristics of photoreceptors.

### DETAILED DESCRIPTION OF THE INVENTION

Fluorescence detection devices according to embodiments of this invention will now be described with reference to the accompanying drawings.

### First Embodiment

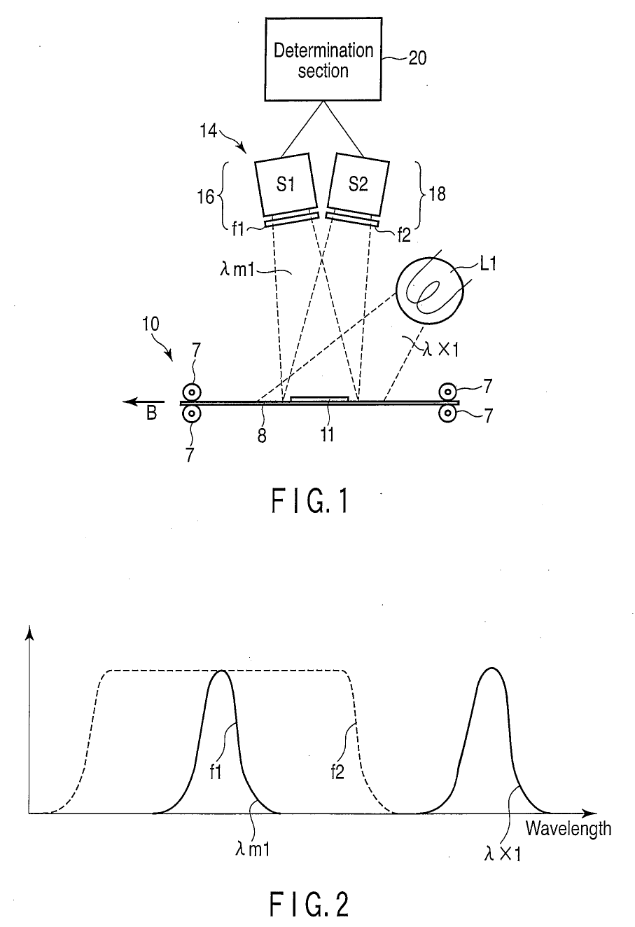

FIG. 1 is a side view schematically showing a fluorescence detection device according to a first embodiment of the invention.

As shown in FIG. 1, the fluorescence detection device is provided with a conveying mechanism 10, illumination device L₁, light receiving system 14, and authentication section 20. The conveying mechanism 10 conveys a standard-size sheet of paper 8 as an inspected medium in a predetermined conveying direction B. A fluorescent printing element 11 that glows at a specific wavelength is attached to the sheet of paper 8. Illumination device L₁ applies illumination light for exciting the fluorescent printing element 11 onto the sheet of paper 8. The light receiving system 14 receives a fluorescence emission from the fluorescent printing element 11. The authentication section 20 authenticates the sheet of paper 8 based on the fluorescence emission detected by the light receiving system 14.

The conveying mechanism 10 includes a plurality of conveyor rollers 7, which nip and convey the sheet of paper 8, a belt, guides (not shown), etc. The standard-size sheet of paper 8 is conveyed in the direction of arrow B by the conveyor rollers 7. Although the sheet of paper 8 is designed to be conveyed by the conveying mechanism 10, it may alternatively be located at rest in a predetermined inspection position.

The fluorescent printing element 11 on the sheet of paper 8 is assumed to include a fluorescent substance, which is excited by light of an excitation wavelength λₓ₁ and emits light of a specific wavelength λₘ₁, for example. Illumination device L₁ is located in a predetermined angular position with respect to the sheet of paper 8 and serves to apply the excitation light to the entire fluorescent printing element 11 on the sheet of paper 8. The light emitted from illumination device L₁ includes a frequency band in which the printing element 11 is excited, that is, a frequency band for at least excitation wavelength λ.

The fluorescent printing element 11, which is excited by the illumination light, emits fluorescent light of specific wavelength λₘₗ, and the emitted light is detected by the light receiving system 14. FIG. 2 shows the light emission characteristics at fluorescence emission wavelength λₘ₁.

As shown in FIG. 1, the light receiving system 14 is provided with first and second photoreceptors 16 and 18. The first photoreceptor 16 has such a characteristic that it receives only light of wavelength λₘ₁. In this case, the first photoreceptor 16 includes an optical sensor S₁ and optical filter f₁ located between the sensor S₁ and inspected medium 8. The optical filter f₁ has such a characteristic that it transmits only light of specific wavelength λₘ₁.

The first photoreceptor 16 characterized in this manner is not limited to the combination of the optical sensor and filter and may also be easily realized by means of an alternative optical member. Although the optical sensor may be a photosensor, CCD, etc., it may be any other suitable type that is sensitive to specific wavelength λₘ₁.

The second photoreceptor 18 has such a characteristic that it broadly receives light components of wavelengths in a wider frequency band that includes specific wavelength λₘ'. In this case, the second photoreceptor 18 includes an optical sensor S₂ and optical filter f₂ located between the sensor S₂ and inspected medium 8. The optical filter f₂ has such a characteristic that it transmits light components of wavelengths in a wide frequency band including specific wavelength λₘₗ. The second photoreceptor 18 characterized in this manner is not limited to the combination of the optical sensor and filter and may also be easily realized by means of an alternative optical member. Although the optical sensor may be a photosensor, CCD, etc., it may be any other suitable type that is sufficiently sensitive to broadly receive light components of wavelengths in a wide frequency band for transmission through the optical filter f₂.

The fluorescent light of specific wavelength λₘₗ emitted from the fluorescent printing element 11 is incident on and received by the first and second photoreceptors 16 and 18. The light received by the first photoreceptor 16 is converted into an electrical signal, which is sent to the authentication section 20. The light received by the second photoreceptor 18 is converted into an electrical signal, which is sent to the authentication section 20.

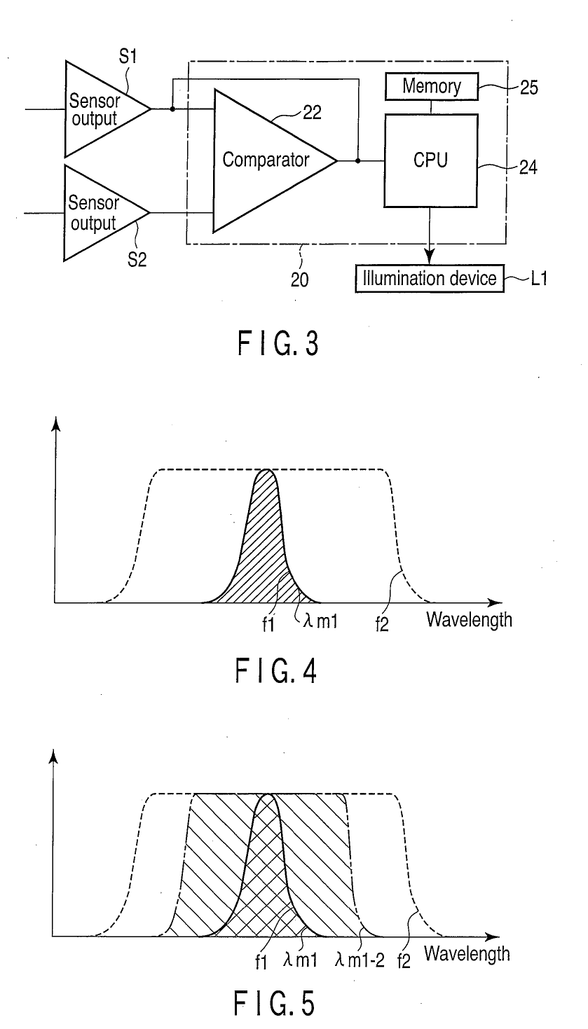

As shown in FIG. 3, the authentication section 20 is provided with a comparator 22 and CPU 24. The comparator 22 receives output signals (detection signals) from the optical sensors S₁ and S₂ and computes them comparatively. The CPU 24 authenticates the fluorescent printing element 11 based on an output from the comparator 22. The output signal from the first photoreceptor 16 may alternatively be sent directly to the CPU 24. The CPU 24 is connected with a memory 25, which stores predetermined data, e.g., the output level of the correct wavelength λₘ₁. The CPU 24 functions as a light emission control section, which controls the illumination device L₁ by means of a driver (not shown).

The following is a description of the detection operation of the fluorescence detection device constructed in this manner.

When the sheet of paper 8 is conveyed to a predetermined detection position by the conveying mechanism 10, as shown in FIG. 1, the fluorescence detection device starts fluorescence detection of the fluorescent printing element 11. First, the illumination device L₁ is turned on under the control of the CPU 24. The light of excitation wavelength λₓ₁ emitted from the illumination device L₁ is applied at a predetermined angle to the fluorescent printing element 11, whereupon the element 11 emits the fluorescent light of specific wavelength λₘ₁. This fluorescent light is received by the first and second photoreceptors 16 and 18.

The optical sensor S₁ of the first photoreceptor 16 receives only light of specific wavelength λₘ₁ transmitted through optical filter f₁ and converts the received fluorescent light of specific wavelength λₙᵢₗ into an electrical signal and outputs it. The output signal from the optical sensor S₁ is sent to the CPU 24 and compared with the normal data at wavelength λₘ₁ stored in the memory 25, whereby it is authenticated.

If the output signal from the first photoreceptor 16 is different from the normal data at wavelength λₘ₁, the fluorescent printing element 11 is determined to be counterfeit, that is, the sheet of paper 8 is determined to be counterfeit. If the output signal from the first photoreceptor 16 is identical with the normal data at wavelength λₘ₁, it is input to the comparator 22.

On the other hand, the optical sensor S₂ of the second photoreceptor 18 receives light in a wide frequency band including specific wavelength λₘ₁ transmitted through the optical filter f₂ and converts the received fluorescent light of specific wavelength λₘ₁ into an electrical signal and outputs it. The output signal from optical sensor S₂ is input to the comparator 22, which comparatively computes the respective output levels of optical sensors S₁ and S₂. As shown in FIG. 4, the output levels may be considered to be the respective areas of the light components transmitted through the optical filters f₁ and f₂. Since specific wavelength λₘ₁ delivered from of the fluorescent printing element 11 is equivalent to the transmission characteristic of the optical filter f₁, the respective output levels of optical sensors S₁ and S₂ are equal. Data on the comparative computation by the comparator 22 is sent to the CPU 24. Since the sensor output levels are equal, the CPU 24 determines that the fluorescent printing element 11 and hence the sheet of paper 8 are real. If the respective output levels of the optical sensors S₁ and S₂ are different, the CPU 24 determines that the fluorescent printing element 11 is counterfeit.

The following is a description of a case where the fluorescent printing element 11 is a fluorescent substance that has a fluorescence emission characteristic λₘ₁₋₂ with a wider frequency band including the specific wavelength λₘₗ.

Fluorescent light of wavelength λₘ₁₋₂ emitted from the fluorescent printing element 11 by excitation light from illumination device L₁ is incident on the first and second photoreceptors 16 and 18. The optical filter f₁ of the first photoreceptor 16, by its transmission characteristic, transmits only light of specific wavelength λₘ₁, so that optical sensor S₁ receives only the light of wavelength λₘ₁. The output level of the electrical signal converted by the optical sensor S₁ represents only a portion transmitted through the optical filter f₁, that is, a portion corresponding to the light of specific wavelength λₘ₁.

The optical filter f₂ of the second photoreceptor 18 has such a characteristic that it transmits light in a wider frequency band including specific wavelength λₘ₁. Therefore, all light components with the fluorescence emission characteristic λₘ₁₋₂ are incident on the optical sensor S₂ of the second photoreceptor 18, so that the output level of the electrical signal converted by the optical sensor S₂ represents the fluorescence emission characteristic λₘ₁₋₂.

Consequently, the respective signal output levels of the first and second photoreceptors 16 and 18, which are comparatively computed by the comparator 22, are not equal, that is, the output level of the second photoreceptor 18 is higher.

Thus, if the fluorescence emission from the fluorescent printing element 11 is at the normal specific wavelength λₘ₁, the signal output levels S₁ and S₂ of the first and second photoreceptors 16 and 18 are equal. In the case of fluorescence emission wavelength λₘ₁₋₂ having a wider frequency band including specific wavelength λₘ₁, the signal output levels S₁ and S₂ are different, that is, S₁<S₂.

If the compared signal output levels S₁ and S₂ are equal, the authentication section 20 determines that the fluorescent substance is a desired one. If not, the fluorescent substance is determined to be an undesired one.

According to the first embodiment, as described above, there is obtained a fluorescence detection device of simple construction capable of accurately detecting a fluorescent substance that glows at a specific wavelength and easily determining the presence of a desired fluorescent substance.

In the present embodiment, (1) the output signal from the first photoreceptor 16 is input to the CPU 24 to authenticate the received fluorescence emission, and (2) the output signals from the first and second photoreceptors 16 and 18 are then compared by the comparator 22. Alternatively, however, process 1 may be omitted so that the fluorescence emission is authenticated in process 2 only.

### Second Embodiment

The following is a description of a fluorescence detection device according to a second embodiment. This fluorescence detection device detects a sheet of paper 8 to which a fluorescent printing element 11 that glows at different specific wavelengths is attached. For example, the fluorescent printing element 11, an object to be detected, is formed by mixing or superposing a fluorescent substance that is excited by light of an excitation wavelength λₓ₁ and glows at a specific wavelength λₘ₁ and a fluorescent substance that is excited by light of an excitation wavelength λₓ₂ and glows at a specific wavelength λₘ₂.

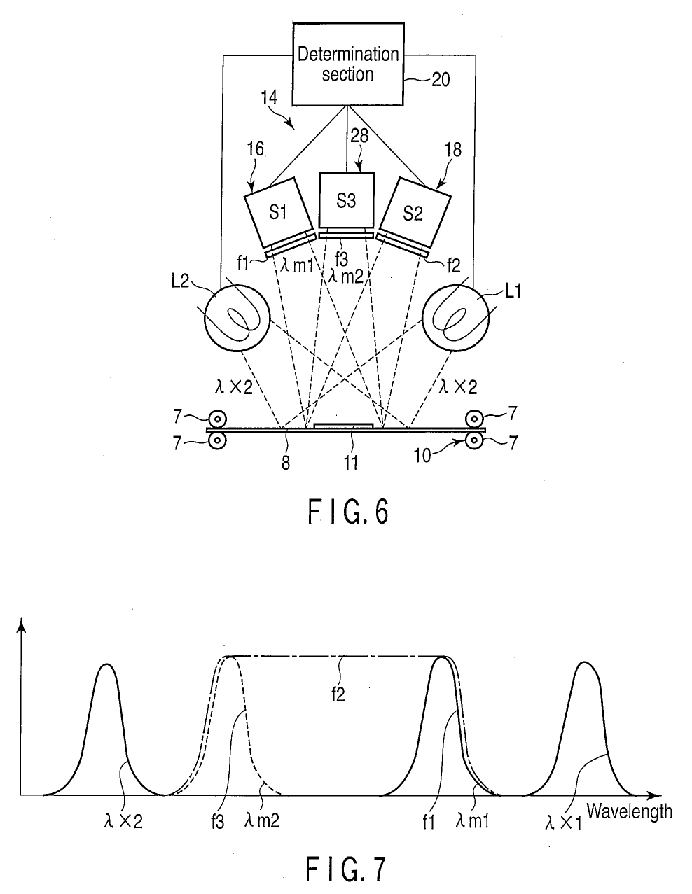

FIG. 6 is a side view schematically showing the fluorescence detection device according to the second embodiment.

As shown in FIG. 6, the fluorescence detection device comprises a conveying mechanism 10, illumination devices L₁ and L₂, light receiving system 14, and authentication section 20. The conveying mechanism 10 conveys the standard-size sheet of paper 8 as an inspected medium, to which the fluorescent printing element 11 is attached, in a predetermined conveying direction B. The illumination devices L₁ and L₂ individually include two independent light sources that individually apply illumination light components for exciting the fluorescent printing element 11 to the sheet of paper 8. The light receiving system 14 receives a fluorescence emission from the fluorescent printing element 11. The authentication section 20 authenticates the sheet of paper 8 based on the fluorescence emission detected by the light receiving system 14.

The conveying mechanism 10 includes a plurality of conveyor rollers 7, which nip and convey the sheet of paper 8, a belt, guides (not shown), etc. The standard-size sheet of paper 8 is conveyed in the direction of arrow B by the conveyor rollers 7. Although the sheet of paper 8 is designed to be conveyed by the conveying mechanism 10, it may alternatively be located at rest in a predetermined inspection position.

FIG. 7 shows characteristics of excitation light components emitted from the illumination devices L₁ and L₂ and characteristics of fluorescence emission from the fluorescent printing element 11. The illumination device L₁ is located in a predetermined angular position with respect to the sheet of paper 8 and serves to apply the excitation light to the entire fluorescent printing element 11 on the sheet of paper 8. The light emitted from the light source of the illumination device L₁ includes a frequency band in which the printing element 11 is excited, that is, frequency band for excitation wavelength λₓ₁. The printing element 11 excited by this illumination light emits fluorescent light of specific wavelength λₘ₁, which is detected by the light receiving system 14.

The illumination device L₂ is located in a predetermined angular position with respect to the sheet of paper 8 and serves to apply the excitation light to the entire fluorescent printing element 11 on the sheet of paper 8. The light emitted from the illumination device L₂ includes a frequency band for excitation wavelength λₓ₂ in which the printing element 11 is excited. The printing element 11 excited by this illumination light emits fluorescent light of specific wavelength λₘ₂, which is detected by the light receiving system 14.

Although laser sources or LEDs may be used as the illumination devices L₁ and L₂, the invention is not limited to this arrangement.

As shown in FIG. 6, the light receiving system 14 is provided with first, third, and second photoreceptors 16, 28 and 18. The first photoreceptor 16 has such a characteristic that it receives only light of specific wavelength (first specific wavelength) λₘ₁. In this case, the first photoreceptor 16 includes an optical sensor S₁ and optical filter f₁ located between the sensor S₁ and inspected medium. The optical filter f₁ has such a characteristic that it transmits only light of specific wavelength λₙᵢₗ.

The first photoreceptor 16 characterized in this manner is not limited to the combination of the optical sensor and filter and may also be easily realized by means of an alternative optical member. Although the optical sensor may be a photosensor, CCD, etc., it may be any other suitable type that is sensitive to specific wavelength λₘ₁.

The third photoreceptor 28 has such a characteristic that it receives only light of specific wavelength (second specific wavelength) λₘ₂. In this case, the third photoreceptor 28 includes an optical sensor S₃ and optical filter f₃ located between the sensor S₃ and inspected medium. The optical filter f₃ has such a characteristic that it transmits only light of specific wavelength λₘ₂.

The third photoreceptor 28 characterized in this manner is not limited to the combination of the optical sensor and filter and may also be easily realized by means of an alternative optical member. Although the optical sensor S₃ may be a photosensor, CCD, etc., it may be any other suitable type that is sensitive to specific wavelength λₘ₂.

The second photoreceptor 18 has such a characteristic that it broadly receives light components of wavelengths in a frequency band that includes specific wavelengths λₘ₁ and λₘ₂ or a wider frequency band. In this case, the second photoreceptor 18 includes an optical sensor S₂ and optical filter f₂ located between the sensor S₂ and inspected medium. The optical filter f₂ has such a characteristic that it transmits light components of wavelengths in a wide frequency band including specific wavelengths λₘ₁ and λₘ₂.

The second photoreceptor 18 characterized in this manner is not limited to the combination of the optical sensor and filter and may also be easily realized by means of an alternative optical member. Although the optical sensor S₂ may be a photosensor, CCD, etc., it may be any other suitable type that is sufficiently sensitive to broadly receive light components of wavelengths in a wide frequency band for transmission through the optical filter f₂.

The fluorescent light of specific wavelength λₘ₁ emitted from the fluorescent printing element 11 is incident on and received by the first and second photoreceptors 16 and 18. The fluorescent light of specific wavelength λₘ₂ emitted from the fluorescent printing element 11 is incident on and received by the third and second photoreceptors 28 and 18. The light components received by the first and second photoreceptors 16 and 18 are converted individually into electrical signals, which are sent to the authentication section 20.

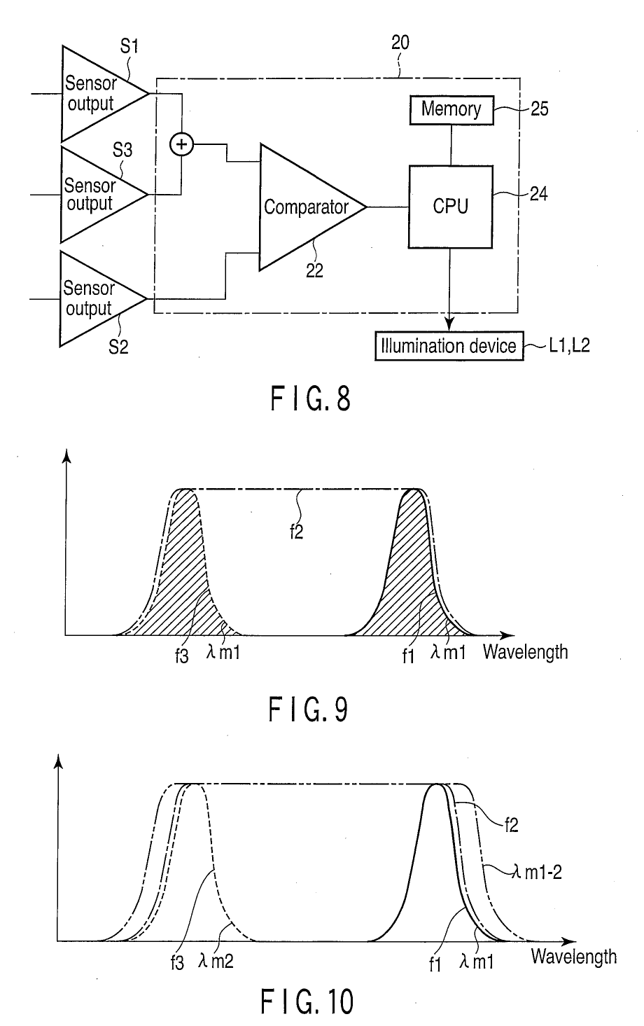

As shown in FIG. 8, the authentication section 20 is provided with a comparator 22 and CPU 24. The comparator 22 receives output signals from the optical sensors S₁, S₃ and S₂ and computes them comparatively. The CPU 24 authenticates the fluorescent printing element 11 based on an output from the comparator 22. The CPU 24 is connected with a memory 25, which stores predetermined data, e.g., the respective output levels of the correct wavelengths λₘ₁ and λₘ₂. Further, the CPU 24 functions as a light emission control section, which controls the illumination devices L₁ and L₂ by means of a driver (not shown).

The following is a description of the detection operation of the fluorescence detection device constructed in this manner.

When the sheet of paper 8 is conveyed to a predetermined detection position by the conveying mechanism 10, as shown in FIG. 6, the fluorescence detection device starts fluorescence detection of the fluorescent printing element 11. The illumination devices L₁ and L₂ are turned on under the control of the CPU 24. The light of excitation wavelength λₓ₁ emitted from the illumination device L₁ is applied at a predetermined angle to the fluorescent printing element 11, whereupon the element 11 emits the fluorescent light of specific wavelength λₘ₁. This fluorescent light is received by the first and second photoreceptors 16 and 18.

The light of wavelength λₓ₂ emitted from the illumination device L₂ is applied at a predetermined angle to the fluorescent printing element 11, whereupon the element 11 emits the fluorescent light of specific wavelength λₘ₂. This fluorescent light is received by the third and second photoreceptors 28 and 18.

The optical sensor S₁ of the first photoreceptor 16 receives only light of specific wavelength λₘ₁ transmitted through the optical filter f₁ and converts the received fluorescent light of wavelength λₘ₁ into an electrical signal and outputs it. The optical sensor S₃ of the third photoreceptor 28 receives only light of specific wavelength λₘ₂ transmitted through the optical filter f₃ and converts the received fluorescent light of wavelength λₘ₂ into an electrical signal and outputs it. The optical sensor S₂ of the second photoreceptor 18 receives light components in a wide frequency band including specific wavelengths λₘ₁ and λₘ₂ transmitted through the optical filter f₂ and converts the received fluorescent light components of wavelengths λₘ₁ and λₘ₂ into electrical signals and outputs them.

Output signals from the first and third photoreceptors 16 and 28 are added together, and a sum output level is input to the comparator 22. Further, an output signal from the second photoreceptor 18 is input to the comparator 22, in which it is computed in comparison with the sum output signal. A signal output level can be regarded as the area of light transmitted through each filter shown in FIG. 9. The light of specific wavelength λₘ₁ emitted from the fluorescent printing element 11 and the optical filter f₁ have equivalent characteristics, while the light of specific wavelength λₘ₂ and the optical filter f₃ has equivalent characteristics. Accordingly, a sum output level obtained by adding up the respective outputs of the optical sensors S₁ and S₃ is equal to the output level of the optical sensor S₂.

Data on the comparative computation by the comparator 22 is sent to the CPU 24. Since the sensor output levels are equal, the CPU 24 determines that the fluorescent printing element 11 and hence the sheet of paper 8 are real. If the sum output level, obtained by adding up the respective outputs of the optical sensors S₁ and S₃, and the output level of the optical sensor S₂ are different, the CPU 24 determines that the fluorescent printing element 11 is counterfeit.

The following is a description of a case where the fluorescent printing element 11 is a fluorescent substance that has a fluorescence emission characteristic λₘ₁₋₂ with a wider frequency band including specific wavelengths λₘ₁ and λₘ₂.

Fluorescent light of wavelength λₘ₁₋₂ emitted from the fluorescent printing element 11 by excitation light components of wavelengths λₘ₁ and λₘ₂ from illumination devices L₁ and L₂ is incident on the first, third, and second photoreceptors 16, 28 and 18. The optical filter f₁ of the first photoreceptor 16, by its transmission characteristic, transmits only light of specific wavelength λₘ₁, so that the optical sensor S₁ receives only light of specific wavelength λₘₗ. The output level of the electrical signal converted by the optical sensor S₁ represents only a portion transmitted through the optical filter f₁, that is, a portion corresponding to the light of specific wavelength λₘ₁. The optical filter f₃ of the third photoreceptor 28, by its transmission characteristic, transmits only light of specific wavelength λₘ₂, so that the optical sensor. S₃ receives only the light of specific wavelength λₘ₂. The output level of the electrical signal converted by the optical sensor S₃ represents only a portion transmitted through the optical filter f₃, that is, a portion corresponding to the light of specific wavelength λₘ₂.

The optical filter f₂ of the second photoreceptor 18 has such a characteristic that it transmits light components in a wider frequency band including specific wavelengths λₘₗ and λₘ₂. Therefore, the optical sensor S₂ of the second photoreceptor 18 receives light at a portion where the transmission characteristic of the optical filter f₂ and the fluorescence emission characteristic λₘ₁₋₂ overlap each other, so that the output level of the electrical signal converted by the optical sensor S₂ represents this overlapping portion.

Consequently, the sum output level of the first and third photoreceptors 16 and 28 and the output level of the second photoreceptor 18, which are comparatively computed by the comparator 22, are not equal, that is, the output level of the optical sensor S₂ of the second photoreceptor 18 is higher.

Thus, if the fluorescence emission from the fluorescent printing element 11 is at specific wavelength λₘ₁ or λₘ₂ only, the output level S₂ of the second photoreceptor 18 and an output level (S₁+S₃), that is, the sum of the respective outputs of the first and third photoreceptors 16 and 28, are equal. In the case of fluorescence emission wavelength λₘ₁₋₂ having a wider frequency band including specific wavelengths λₘ₁ and λₘ₂, the output levels of the first and second photoreceptors are defined by (S₁+S₃)<S₂.

If the compared signal output levels are equal, the authentication section 20 determines that the fluorescent printing element 11 is a desired one. If not, the printing element is determined to be an undesired one.

According to the second embodiment, as described above, there is obtained a fluorescence detection device of simple construction capable of accurately detecting a fluorescent substance that glows at a plurality of different specific wavelengths and easily determining the presence of a desired fluorescent substance.

Although the detection of the fluorescence that glows at two different specific wavelengths has been described in connection with the second embodiment, the invention is not limited to this detection and is also applicable to the detection of a fluorescent substance that glows at three or more different emission wavelengths. The number of detection wavelengths can be increased if a photoreceptor having such a characteristic as to transmit only light components of additional wavelengths is added, and in addition, if the second photoreceptor is configured to receive light components in a frequency band including the additional wavelengths.

### Third Embodiment

The following is a description of a fluorescence detection device according to a third embodiment. This fluorescence detection device detects a sheet of paper 8 to which a fluorescent printing element 11 that glows at different specific wavelengths is attached. For example, the fluorescent printing element 11, an object to be detected, is formed by mixing or superposing a fluorescent substance that is excited by light of an excitation wavelength λₓ₁ and glows at a specific wavelength λₘ₁ and a fluorescent substance that is excited by light of an excitation wavelength λₓ₂ and glows at a specific wavelength λₘ₂.

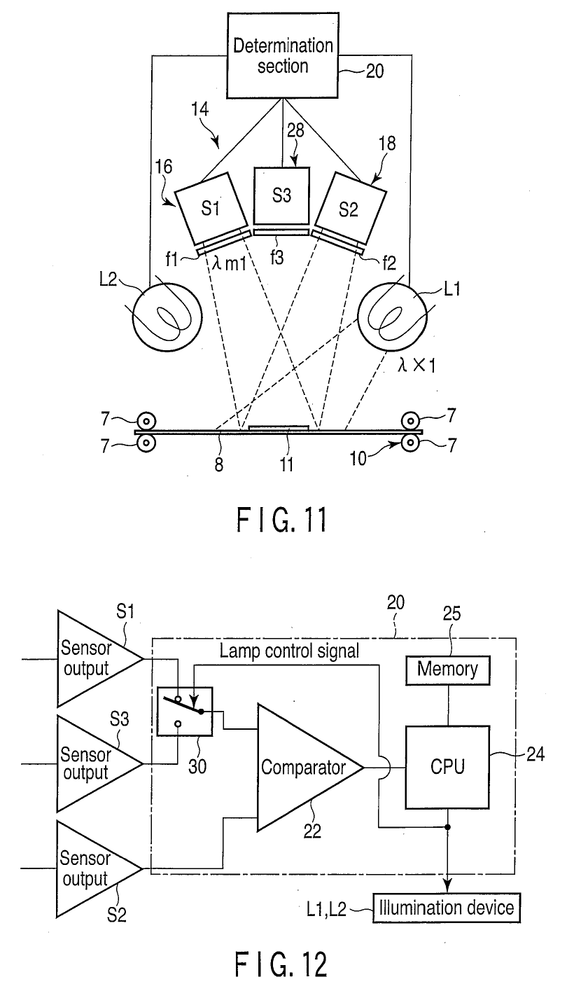

The fluorescence detection device according to the third embodiment is constructed in the same manner as the device of the second embodiment. Specifically, as shown in FIG. 11, the fluorescence detection device is provided with a conveying mechanism 10, two illumination devices L₁ and L₂, light receiving system 14, and authentication section 20. The conveying mechanism 10 conveys the standard-size sheet of paper 8 as an inspected medium, to which the fluorescent printing element 11 is attached, in a predetermined conveying direction B. The illumination devices L₁ and L₂ individually apply illumination light components for exciting the fluorescent printing element 11 to the sheet of paper 8. The light receiving system 14 includes first, third, and second photoreceptors 16, 28 and 18, which receive a fluorescence emission from the fluorescent printing element 11. The authentication section 20 authenticates the sheet of paper 8 based on the fluorescence emission detected by the light receiving system 14.

As shown in FIG. 12, the authentication section 20 is provided with a comparator 22 and CPU 24. The comparator 22 receives output signals from optical sensors S₁, S₃ and S₂ and computes them comparatively.

The CPU 24 authenticates the fluorescent printing element 11 based on an output from the comparator 22. The CPU 24 is connected with a memory 25, which stores predetermined data, e.g., the output levels of the correct wavelengths λₘ₁ and λₘ₂. Further, the CPU 24 functions as a light emission control section, which outputs lamp control signals to the illumination devices L₁ and L₂, thereby controlling devices L₁ and L₂ by means of a driver (not shown). Furthermore, the authentication section 20 includes a transfer switch 30 that connects the optical sensors S₁ and S₃ alternatively to the comparator 22. The transfer switch 30 is changed in association with the lamp control signals from the CPU 24.

The following is a description of the detection operation of the fluorescence detection device constructed in this manner.

When the sheet of paper 8 is conveyed to a predetermined detection position by the conveying mechanism 10, as shown in FIG. 11, the fluorescence detection device starts fluorescence detection of the fluorescent printing element 11. First, the illumination devices L₁ and L₂ are turned on and off, respectively, under the control of the CPU 24. The light of excitation wavelength λₓ₁ emitted from the illumination device L₁ is applied at a predetermined angle to the fluorescent printing element 11, whereupon the element 11 emits the fluorescent light of specific wavelength λₘ₁. This fluorescent light is received by the first and second photoreceptors 16 and 18.

The light of specific wavelength λₘ₁ incident on the first photoreceptor 16 and received by the optical sensor S₁ is converted into an electrical signal. Since the third photoreceptor 28 is not sensitive to specific wavelength λₘ₁, the electrical signal cannot be output. The light of specific wavelength λₘ₁ incident on the second photoreceptor 18 is received by the optical sensor S₂ and converted into an electrical signal.

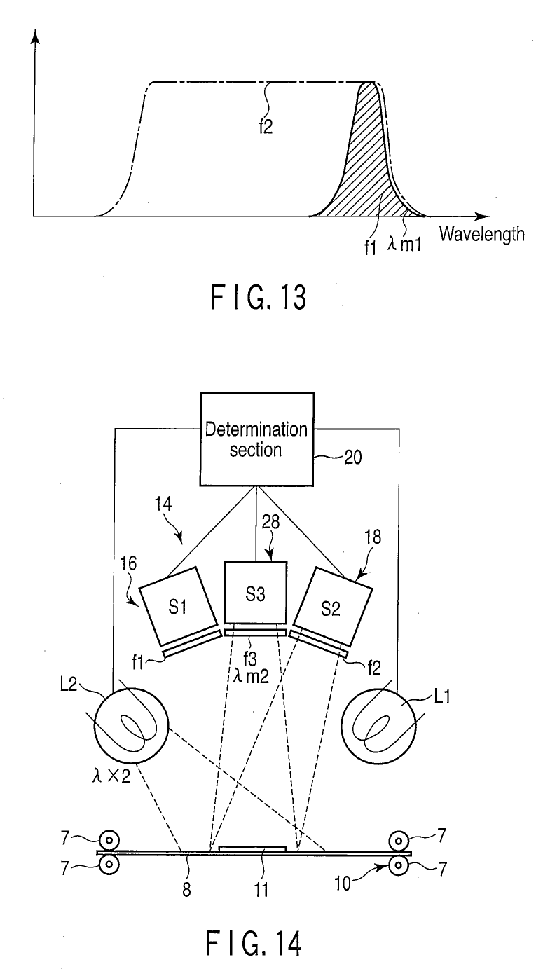

When the illumination device L₁ is turned on in response to the lamp control signal from the CPU 24, as shown in FIG. 12, the transfer switch 30 is changed in association with it, whereupon the first photoreceptor 16 is selected. Thus, the output signals from the optical sensors S₁ and S₂ are input to the comparator 22, in which they are computed comparatively. An output level can be regarded as the area of light transmitted through each of optical filters f₁ and f₂, as shown in FIG. 13. Since the light of specific wavelength λₘ₁ emitted from the fluorescent printing element 11 and the optical filter f₁ have equivalent characteristics, the respective output levels of the optical sensors S₁ and S₂ are equal.

Then, the illumination devices L₂ and L₁ are turned on and off, respectively, under the control of the CPU 24, as shown in FIG. 14. The light of excitation wavelength λₓ₂ emitted from the illumination device L₂ is applied at a predetermined angle to the fluorescent printing element 11, whereupon the element 11 emits the fluorescent light of specific wavelength λₘ₂. This fluorescent light is received by the third and second photoreceptors 28 and 18.

The light of specific wavelength λₘ₂ incident on the third photoreceptor 28 and received by the optical sensor S₃ is converted into an electrical signal. Since the first photoreceptor 16 is not sensitive to specific wavelength λₘ₂, the electrical signal cannot be output. The light of specific wavelength λₘ₂ incident on the second photoreceptor 18 is received by the optical sensor S₂ and converted into an electrical signal.

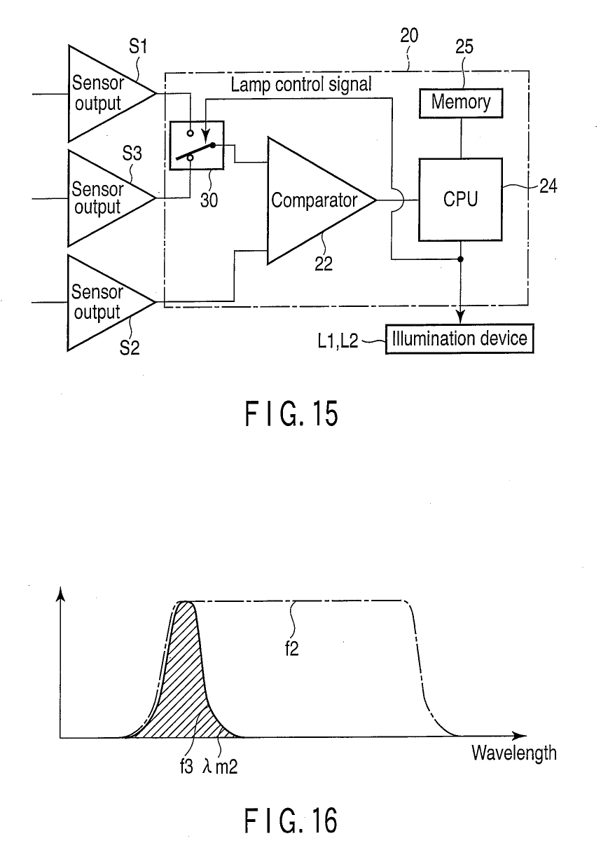

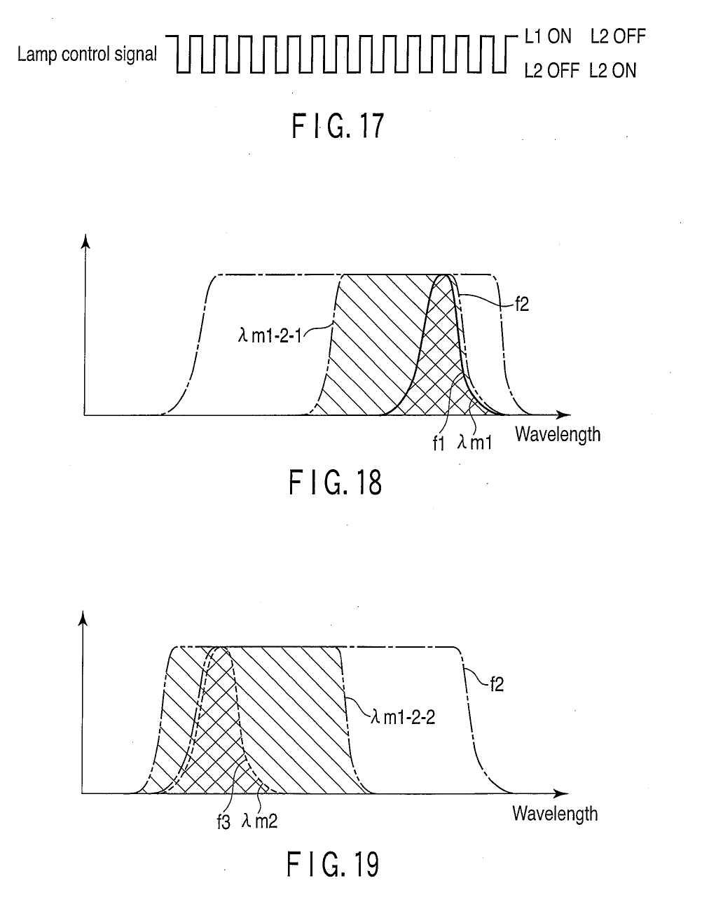

When the illumination device L₂ is turned on in response to the lamp control signal from the CPU 24, as shown in FIG. 15, the transfer switch 30 is changed in association with it, whereupon the third photoreceptor 28 is selected. Thus, the output signals from the optical sensors S₃ and S₂ are input to the comparator 22, in which they are computed comparatively. An output level can be regarded as the area of light transmitted through each of the optical filters f₃ and f₂, as shown in FIG. 16. Since the light of specific wavelength λₘ₂ emitted from the fluorescent printing element 11 and the optical filter f₃ have equivalent characteristics, the respective output levels of the optical sensors S₃ and S₂ are equal. The illumination devices L₁ and L₂ are repeatedly turned on and off in response to a lamp control signal from the CPU 24 shown in FIG. 17.

Data on the comparative computation by the comparator 22 is sent to the CPU 24. If the respective output levels of the optical sensors S₁ and S₂ are equal and if those of the optical sensors S₃ and S₂ are equal, the CPU 24 determines that the fluorescent printing element 11 and hence the sheet of paper 8 are real. If the output levels of the optical sensors S₁ and S₂ are different or if those of the optical sensors S₃ and S₂ are different, the CPU 24 determines that the fluorescent printing element 11 and hence the sheet of paper 8 are counterfeit.

The following is a description of a case where the fluorescent printing element 11 is a fluorescent substance that has a fluorescence emission characteristic λₘ₁₋₂₋₁ with a wider frequency band including specific wavelength λml or a fluorescent substance that has a fluorescence emission characteristic λₘ₁₋₂₋₂ with a wider frequency band including specific wavelength λₘ₂.

First, the illumination devices L₁ and L₂ are turned on and off, respectively, as shown in FIG. 11. As shown in FIG. 18, fluorescent light of wavelength λₘ₁₋₂₋₁ emitted from the fluorescent printing element 11 by excitation light λₓ₁ is incident on the first and second photoreceptors 16 and 18. Due to the transmission characteristic of the optical filter f₁, the first photoreceptor 16 receives only light in the transmission band λₘ₁ of the optical filter f₁. The output level of the converted electrical signal represents only a portion corresponding to the light of specific wavelength λₘ₁ transmitted through the optical filter f₁.

Since the second photoreceptor 18 has such a characteristic that it broadly transmits light components in a frequency band that includes the optical filters f₁ and f₂ or a wider frequency band, it receives light of wavelength λₘ₁₋₂₋₁ transmitted through the optical filter f₂. The output level of the electrical signal converted by the optical sensor S₂ represents a portion where wavelength λₘ₁₋₂₋₁ and the optical filter f₂ overlap each other.

When the respective output levels of the first and second photoreceptors 16 and 18 are comparatively computed by the comparator 22, the output level of the second photoreceptor 18 is found to be higher.

Then, the illumination devices L₁ and L₂ are turned off and on, respectively, as shown in FIG. 14. As shown in FIG. 19, fluorescent light of wavelength λₘ₁₋₂₋₂ emitted by excitation light λₓ₂ is incident on the third and second photoreceptors 28 and 18. Due to the transmission characteristic of the optical filter f₃, the third photoreceptor 28 receives only light in the transmission band λₘ₂ of the optical filter f₃. The output level of the electrical signal converted by the optical sensor S₃ represents only a portion corresponding to the light of specific wavelength λₘ₂ transmitted through the optical filter f₃.

Since the second photoreceptor 18 has such a characteristic that it broadly transmits light components in a frequency band that includes the optical filters f₁ and f₃ or a wider frequency band, its optical sensor S₂ receives light of wavelength λₘ₁₋₂₋₂ transmitted through the optical filter f₂. The output level of the electrical signal converted by the optical sensor S₂ represents a portion where wavelength λₘ₁₋₂₋₂ and the optical filter f₂ overlap each other.

When the respective output levels of the optical sensors S₃ and S₂ of the third and second photoreceptors 28 and 18 are comparatively computed by the comparator 22, the output level of the second photoreceptor 18 is found to be higher.

Thus, if the fluorescence emission from the fluorescent printing element 11 is at the normal specific wavelengths λₘ₁ and λₘ₂ only, the respective output levels of the first and second photoreceptors 16 and 18 are equal, and those of the third and second photoreceptors 28 and 18 are equal. If the fluorescence emission from the fluorescent printing element 11 is at fluorescence emission wavelength λₘ₁₋₂₋₁ or λₘ₁₋₂₋₂ having the wider frequency band including specific wavelengths λₘ₁ and λₘ₂, on the other hand, the output levels of the first, third, and second photoreceptors 16, 28 and 18 are defined by S₁<S₂ and S₃<S₂. If the compared output levels are equal, the authentication section 20 determines that the fluorescent substance is a desired one. If not, the fluorescent substance is determined to be an undesired one.

According to the third embodiment, as described above, there is obtained a fluorescence detection device of simple construction capable of accurately detecting a fluorescence that glows at a plurality of different specific wavelengths and easily determining the presence of a desired fluorescent substance. By separately detecting and comparing the plurality of specific wavelengths λₘ₁ and λₘ₂, moreover, the fluorescence emission from the fluorescent printing element can be detected more accurately than in the second embodiment.

Although the detection of the fluorescent substance that glows at two different specific wavelengths has been described in connection with the third embodiment, the invention is not limited to this detection and is also applicable to the detection of a fluorescent substance that glows at three or more different emission wavelengths. The number of detection wavelengths can be increased if a photoreceptor having such a characteristic as to transmit only light components of additional wavelengths is added, and in addition, if the second photoreceptor is configured to receive light in a frequency band including the additional wavelengths.

The present invention is not limited directly to the embodiments described above, and its components may be embodied in modified forms without departing from the scope or spirit of the invention. Further, various inventions may be made by suitably combining a plurality of components described in connection with the foregoing embodiments. For example, some of the components according to the foregoing embodiments may be omitted. Furthermore, components according to different embodiments may be combined as required.

For example, the inspected medium as an object of inspection is not limited to the sheet of paper and may alternatively be a card, gift certificate, securities, etc.

What is claimed is:

1. A fluorescence detection device for detecting a fluorescent substance which is attached to an inspected medium and glows at a specific wavelength, comprising:
an illumination device configured to apply excitation light for exciting the fluorescent substance to the inspected medium;
a first photoreceptor configured to receive excited light from the fluorescent substance of the inspected medium and detect only light of the specific wavelength;
a second photoreceptor configured to receive excited light from the fluorescent substance of the inspected medium and detect light in a wider frequency band including the specific wavelength; and
an authentication section configured to authenticate the fluorescent substance based on detection signals from the first and second photoreceptors.

2. The fluorescence detection device according to claim 1, wherein the authentication section is configured to compare the detection signals from the first and second photoreceptors, determine the fluorescent substance to be real if the detection signals are equal, and determine the fluorescent substance to be counterfeit if the detection signals are different.

3. The fluorescence detection device according to claim 2, wherein the first photoreceptor includes an optical filter configured to transmit only light of the specific wavelength and an optical sensor configured to detect the light transmitted through the optical filter, and the second photoreceptor includes an optical filter configured to transmit light in the wider frequency band including the specific wavelength and an optical sensor configured to detect the light transmitted through the optical filter.

4. A fluorescence detection device for detecting a fluorescent substance which is attached to an inspected medium and glows at a plurality of different specific wavelengths, comprising:
an illumination device configured to apply a plurality of excitation light components of different wavelengths for individually exciting the fluorescent substance to the inspected medium;
a first photoreceptor configured to receive excited light from the fluorescent substance of the inspected medium and detect only light of a first one of the different specific wavelengths;
a third photoreceptor configured to receive excited light from the fluorescent substance of the inspected medium and detect only light of a second one of the different specific wavelengths;
a second photoreceptor configured to receive excited light from the fluorescent substance of the inspected medium and detect light in a wider frequency band including the first and second specific wavelengths; and
an authentication section configured to authenticate the fluorescent substance based on detection signals from the first, third, and second photoreceptors.

5. The fluorescence detection device according to claim 4, wherein the authentication section is configured to compare the detection signal from the second photoreceptor with the sum of the detection signals from the first and third photoreceptors, determine the fluorescent substance to be real if the compared values are equal, and determine the fluorescent substance to be counterfeit if the compared values are different.

6. The fluorescence detection device according to claim 4, wherein the authentication section is configured to compare the detection signals from the first and second photoreceptors, compare the detection signals from the third and second photoreceptors, determine the fluorescent substance to be real if the compared values are equal in both cases, and determine the fluorescent substance to be counterfeit if the compared values are not equal in both cases.

7. The fluorescence detection device according to claim 4, wherein the first photoreceptor includes a first optical filter configured to transmit only light of the first specific wavelength and a first optical sensor configured to detect the light transmitted through the first optical filter, the third photoreceptor includes a third optical filter configured to transmit light in the wider frequency band including the specific wavelength and a third optical sensor configured to detect the light transmitted through the third optical filter, and the second photoreceptor includes a second optical filter configured to transmit light in the wider frequency band including the first and second specific wavelengths and a second optical sensor configured to detect the light transmitted through the second optical filter.

8. The fluorescence detection device according to claim 4, wherein the illumination device includes a plurality of independent light sources corresponding individually to a plurality of different excitation wavelengths, and the authentication section is provided with a light source controller configured to switch and repeatedly alternately turn on and off the light sources.
